(19) United States
(12) Patent Application Publication
(10) Pub. No.: US 2023/0230152 A1
(43) Pub. Date: Jul. 20, 2023

(54) SYSTEMS AND METHODS FOR GENERATING CUSTOMIZED AUGMENTED REALITY VIDEO

(71) Applicant: SHOPIFY INC., Ottawa (CA)

(72) Inventors: Adam DEBRECZENI, Bozeman, MT (US); Brennan LETKEMAN, Calgary (CA); Russ MASCHMEYER, Berkeley, CA (US)

(21) Appl. No.: 17/576,684

(22) Filed: Jan. 14, 2022

(51) Int. Cl. G06Q 30/06; G06F 3/04815; G06T 19/00

(52) U.S. Cl. CPC G06Q 30/0643; G06F 3/04815; G06T 19/006

(57) ABSTRACT

Methods and systems are disclosed for generating an augmented reality (AR) video. A set of products is obtained, where each product is associated with a respective virtual model and a respective object class. An AR video segment is generated for each product in the set of products. In a real-world video segment, a real-world object belonging to a relevant object class that is relevant to the object class of the given product is detected. A render of the virtual model associated with the given product is overlaid in the real-world video segment to obtain the AR video segment. The render of the virtual model is overlaid relative to the detected real-world object belonging to the relevant object class. A continuous AR video is generated from the AR video segments and outputted to be viewable by a user device.

### FIELD

The present disclosure relates to methods and systems for generating an augmented reality video, including generating a customized augmented reality video that, in some embodiments, may be interactive.

### BACKGROUND

Augmented reality (AR) relates to the enhancement of real-world experiences using computer-generated or virtual content. In some cases, AR enables a user to interact with an environment that involves both real-world and virtual components. For example, an AR image or video may involve a virtual object being displayed together with real-world objects in the scene.

### SUMMARY

Many existing AR technologies involve the user only as a passive consumer of AR media (e.g., viewing virtual objects or virtual information displays overlaid on a view of the physical environment). The ability for a user to actively interact with the AR environment, such as creating an AR video, has been limited by the capabilities of at least some existing technologies. For example, existing solutions may only allow a user to capture a static video of an AR experience, that AR content not being editable as AR (as opposed to mere video frames) at a later time.

For example, some existing AR technologies have been developed to enable a user to virtually “try on” a product (e.g., use AR to overlay a virtual model of the product onto a real-world video of the user). However, such technologies typically are limited to viewing one virtual model in one AR video. A user who wishes to virtually try on multiple products typically must go through the necessary interactions (e.g., select a product to virtually try on, capture a live video of themselves, and start the AR rendering) for each product, which is tedious and also consumes added computing resources (e.g., use of processing power to process user inputs, use of network resources to communicate each request for a virtual model to a server, etc.).

Another drawback of some existing AR technologies is that in some cases it can be difficult or impossible for the user to share the AR video with other users (e.g., the user may not be able to save the AR video, or even if the AR video can be saved the user may not be provided with any mechanism for allowing other users to view the AR video). In particular, a user who is using the AR video to virtually try on a product may wish to solicit feedback from other users, but may not be provided with a mechanism for doing so or may be faced with the ability to share only video corresponding to a capture of their AR session. Additionally, even if such a static video or even an AR video can be shared with other users, feedback that can be provided to the user typically is very basic (e.g., a text comment, or a “like” or upvote).

In various examples, the present disclosure describes methods and systems that enable a user to more easily create a customized AR video, which may be viewed by the user and/or other users. An AR video may be automatically generated, which is customized to a user-specific set of products. The virtual model for each product in the set of products may be automatically loaded and overlaid on a corresponding real-world video segment to generate an AR video segment for each product, then the AR video segments may be automatically combined together to generate an AR video. This provides the technical advantage that an AR video that is customized to a user-specific set of products can be generated with little user input.

In some examples, the generated AR video can be shared with other users in an interactive manner. For example, recipients of the AR video may be enabled to modify the AR video by adding additional AR video segments or modifying existing AR video segments. For example, a recipient of the AR video may be enabled to switch a virtual model for a product in an existing AR video segment for another virtual model for another product. This provides the technical advantage that the generated AR video can be used to solicit more sophisticated and informative feedback from other users.

In some examples, the generated AR video may be shared with other users as part of an interactive poll. Examples of the disclosed methods and systems may enable a transaction for a product, a virtual model of which is included in a segment of the AR video, to be automatically completed, based on the results of the interactive poll.

In some example aspects, the present disclosure describes a system including a processing unit configured to execute instructions to cause the system to: obtain a set of products, each product being associated with a respective virtual model and associated with a respective object class; generate a respective augmented reality (AR) video segment for each given product in the set of products by: detecting, in a real-world video segment, a real-world object belonging to a relevant object class that is relevant to the object class of the given product; and overlaying a render of the virtual model associated with the given product in the real-world video segment to obtain the respective AR video segment, the render of the virtual model being overlaid relative to the detected real-world object belonging to the relevant object class; generate a continuous AR video from the AR video segments; and output the continuous AR video to be viewable by a user device.

In any of the preceding examples, for at least one product in the set of products, generating the respective AR video segment may further include: identifying the object class of the given product and identifying the relevant object class; and retrieving a stored real-world video segment, wherein the stored real-world video segment is identified based on metadata indicating the stored real-world video segment contains one or more real-world objects belonging to the relevant object class.

In any of the preceding examples, for at least one product in the set of products, generating the respective AR video segment may further include: detecting the real-world object by: obtaining one or more live frames of real-world video from the user device; and detecting the real-world object and identifying the object class of the real-world object from the one or more live frames; wherein the given product is selected from the set of products to generate the respective AR video segment based on relevancy between the object class of the real-world object and the object class of the given product.

In any of the preceding examples, the processing unit may be configured to execute instructions to further cause the system to: detect, in a sequence of live frames a defined gesture or a pause in motion of the real-world object for at least a defined time threshold; and responsive to the detecting, label at least one frame in the sequence of live frames as a start of a new real-world video segment.

In any of the preceding examples, the processing unit may be configured to execute instructions to further cause the system to: detect, in a sequence of live frames a change from a first real-world object belonging to a first object class to a second real-world object belonging to a different second object class; and responsive to the detecting, label at least one frame in the sequence of live frames as a start of a new real-world video segment.

In any of the preceding examples, the user device may be a first user device, and the processing unit may be configured to execute instructions to further cause the system to: output the continuous AR video to be viewable by at least one second user device; receive feedback, from the at least one second user device, with respect to the continuous AR video; and output collected feedback to the first user device.

In any of the preceding examples, the feedback may include a selection of an additional product not included in the set of products, and output of the collected feedback to the first user device may include a new AR video segment generated by: identifying a real-world video segment associated with a first user associated with the first user device, the identified real-world video segment including a real-world object belonging to an object class that is relevant to an object class of the additional product; and overlaying a render of a 3D model associated with the additional product in the identified real-world video segment to obtain the new AR video segment.

In any of the preceding examples, the feedback may include a positive response to at least one product associated with an AR video segment in the continuous AR video, and the processing unit may be configured to execute instructions to further cause the system to: automatically complete a transaction to purchase a product associated with a AR video segment having a highest positive response from among all products associated with AR video segments in the continuous AR video, the transaction being completed using stored financial information associated with a first user associated with the first user device; and output of the collected feedback to the first user device may include an indication of the completed transaction.

In any of the preceding examples, the system may be the user device, and the user device may be one of: a mobile communication device; a tablet device; a laptop device; a wearable device; or a desktop device.

In some example aspects, the present disclosure describes a method including: obtaining a set of products, each product being associated with a respective virtual model and associated with a respective object class; generating a respective augmented reality (AR) video segment for each given product in the set of products by: detecting, in a real-world video segment, a real-world object belonging to a relevant object class that is relevant to the object class of the given product; and overlaying a render of the virtual model associated with the given product in the real-world video segment to obtain the respective AR video segment, the render of the virtual model being overlaid relative to the detected real-world object belonging to the relevant object class; generating a continuous AR video from the AR video segments; and outputting the continuous AR video to be viewable by a user device.

In any of the preceding examples, for at least one product in the set of products, generating the respective AR video segment may further include: identifying the object class of the given product and identifying the relevant object class; and retrieving a stored real-world video segment, wherein the stored real-world video segment is identified based on metadata indicating the stored real-world video segment contains one or more real-world objects belonging to the relevant object class.

In any of the preceding examples, for at least one product in the set of products, generating the respective AR video segment may further include: detecting the real-world object by: obtaining one or more live frames of real-world video from the user device; and detecting the real-world object and identifying the object class of the real-world object from the one or more live frames; wherein the given product is selected from the set of products to generate the respective AR video segment based on relevancy between the object class of the real-world object and the object class of the given product.

In any of the preceding examples, the method may further include: detecting, in a sequence of live frames a defined gesture or a pause in motion of the real-world object for at least a defined time threshold; and responsive to the detecting, labeling at least one frame in the sequence of live frames as a start of a new real-world video segment.

In any of the preceding examples, the method may further include: detecting, in a sequence of live frames a change from a first real-world object belonging to a first object class to a second real-world object belonging to a different second object class; and responsive to the detecting, labeling at least one frame in the sequence of live frames as a start of a new real-world video segment.

In any of the preceding examples, the user device may be a first user device, and the method may further include: outputting the continuous AR video to be viewable by at least one second user device; receiving feedback, from the at least one second user device, with respect to the continuous AR video; and outputting collected feedback to the first user device.

In any of the preceding examples, the feedback may include a selection of an additional product not included in the set of products, and output of the collected feedback to the first user device may include a new AR video segment generated by: identifying a real-world video segment associated with a first user associated with the first user device, the identified real-world video segment including a real-world object belonging to an object class that is relevant to an object class of the additional product; and overlaying a render of a 3D model associated with the additional product in the identified real-world video segment to obtain the new AR video segment.

In any of the preceding examples, the feedback may include a positive response to at least one product associated with an AR video segment in the continuous AR video, and the method may further include: automatically completing a transaction to purchase a product associated with a AR video segment having a highest positive response from among all products associated with AR video segments in the continuous AR video, the transaction being completed using stored financial information associated with a first user associated with the first user device; and wherein output of the collected feedback to the first user device includes an indication of the completed transaction.

In some example aspects, the present disclosure describes a computer readable medium having instructions encoded thereon, where the instructions, when executed by a computing system, cause the computing system to: obtain a set of products, each product being associated with a respective virtual model and associated with a respective object class; generate a respective augmented reality (AR) video segment for each given product in the set of products by: detecting, in a real-world video segment, a real-world object belonging to a relevant object class that is relevant to the object class of the given product; and overlaying a render of the virtual model associated with the given product in the real-world video segment to obtain the respective AR video segment, the render of the virtual model being overlaid relative to the detected real-world object belonging to the relevant object class; generate a continuous AR video from the AR video segments; and output the continuous AR video to be viewable by a user device.

In any of the preceding examples, for at least one product in the set of products, generating the respective AR video segment may further include: identifying the object class of the given product and identifying the relevant object class; and retrieving a stored real-world video segment, wherein the stored real-world video segment is identified based on metadata indicating the stored real-world video segment contains one or more real-world objects belonging to the relevant object class.

In any of the preceding examples, for at least one product in the set of products, generating the respective AR video segment may further include: detecting the real-world object by: obtaining one or more live frames of real-world video from the user device; and detecting the real-world object and identifying the object class of the real-world object from the one or more live frames; where the given product may be selected from the set of products to generate the respective AR video segment based on relevancy between the object class of the real-world object and the object class of the given product.

In any of the preceding examples, the computer readable medium may include instructions to implement any of the systems or methods described above.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of an example e-commerce platform, including a UI content generator, in which examples described herein may be implemented;

FIG. 4 is another block diagram of an example e-commerce platform, showing example details of an AR video generator, in accordance with examples of the present disclosure;

FIG. 5 is a flowchart illustrating an example method for generating an AR video, in accordance with examples of the present disclosure;

FIGS. 6A and 6B are flowcharts illustrating example methods that may be used to implement steps of the example method of FIG. 5, in accordance with examples of the present disclosure; and

FIG. 7 illustrates an example interface for viewing an AR a video, in accordance with examples of the present disclosure.

Similar reference numerals may have been used in different figures to denote similar components.

### DETAILED DESCRIPTION

Examples of the present disclosure are described in the context of an e-commerce platform. However, it should be understood that the e-commerce platform described herein is only one possible example and is not intended to be limiting. It should be understood that the present disclosure may be implemented in other contexts, and is not necessarily limited to implementation in an e-commerce platform.

### An Example e-Commerce Platform

Although integration with a commerce platform is not required, in some embodiments, the methods disclosed herein may be performed on or in association with a commerce platform such as an e-commerce platform. Therefore, an example of a commerce platform will be described.

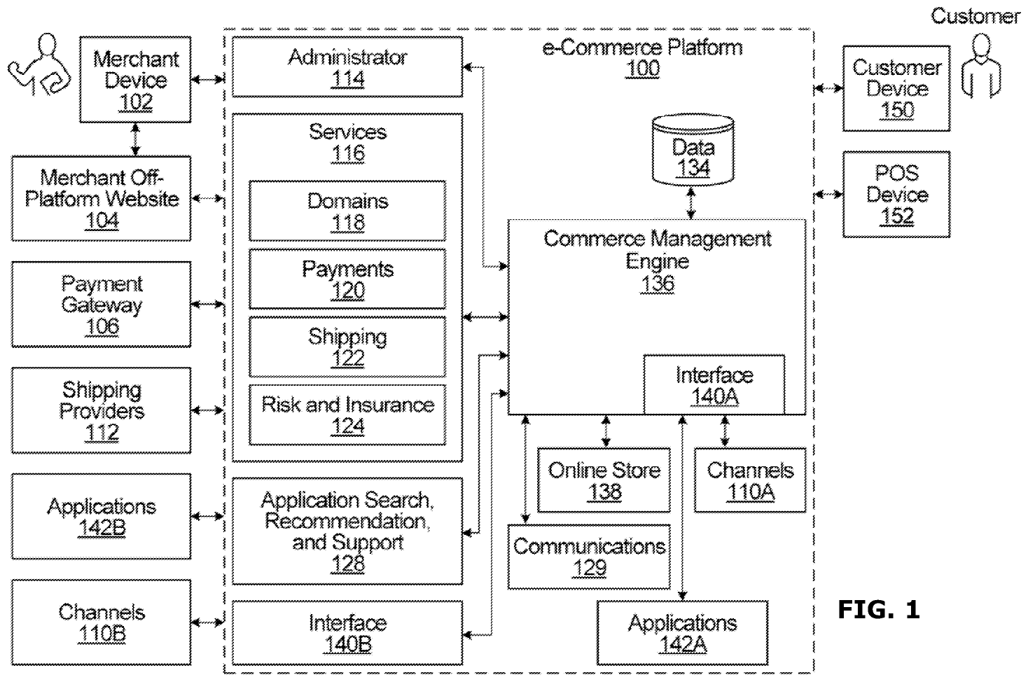

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

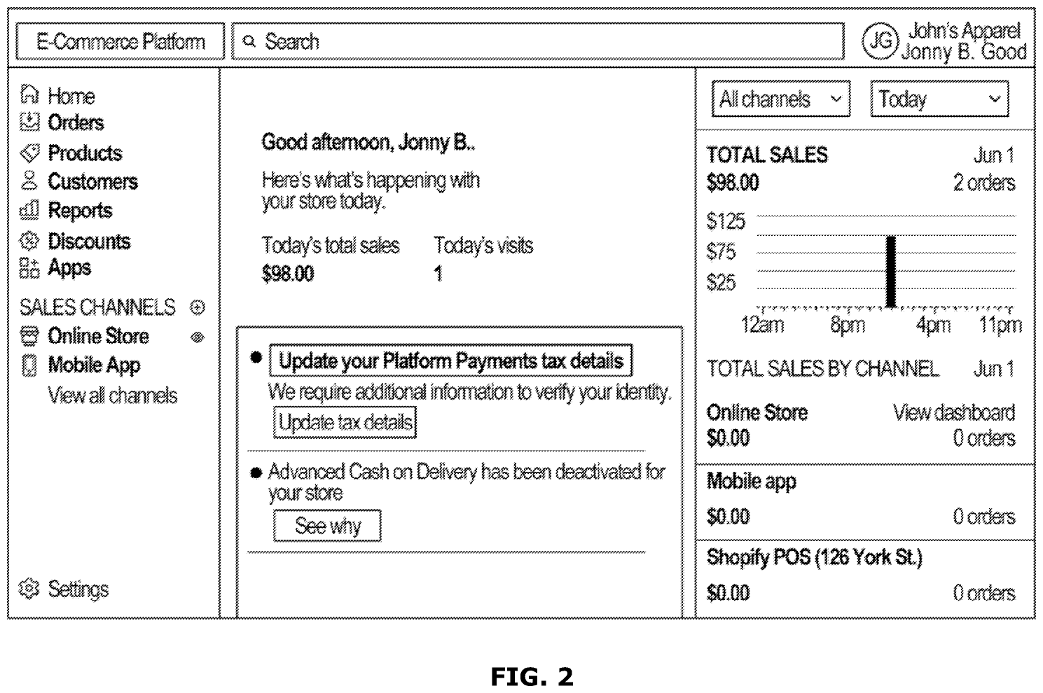

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Implementation in an e-Commerce Platform

The functionality described herein may be used in commerce to provide improved customer or buyer experiences. The e-commerce platform 100 could implement the functionality for any of a variety of different applications, examples of which are described elsewhere herein. In particular, examples of the present disclosure describe functionality of the e-commerce platform 100 to enable generation and/or viewing of augmented reality (AR) videos. For example, the e-commerce platform 100 may generate an AR video to be viewed by a user (e.g., a customer) via a user device (e.g., customer device 150), to enable the user to view a virtual model of a product of interest overlaid in a real-world scene (e.g., a virtual model of a piece of furniture overlaid in the user's real-world room; or a virtual model of a piece of clothing overlaid on the user's real-world body).

The following discussion makes reference to video segments of a video. In general, a video segment may be defined as a continuous portion of a video that has a defined start and end (e.g., defined starting frame and defined ending frame) within the frames of the video. A video may be partitioned (or segmented) into two or more video segments. A video may also be generated by combining two or more video segments. Various techniques may be used to combine the video segments such that multiple video segments can be viewed by a user as a seamless, continuous, single video, some of which will be discussed further below. In some examples, a video segment may be played by itself (i.e., without being combined with another video segment), in which case the video segment may itself be considered a complete video.

In the context of the present disclosure, a virtual object that “overlays” or is “overlaid” onto a real-world scene may visually obscure at least part of a background or other object in the real-world scene. For example, in an AR video, a virtual object may overlay a real-world object such that the virtual object completely blocks the user's view of the real-world object (thus completely replacing or hiding the real-world object in the AR video) or partially blocks the user's view of the real-world object (thus appearing to sit on top of or be part of the real-world object in the AR video).

A virtual model in the present disclosure may be a static model or a dynamic model (e.g., the virtual model may change positions and/or may change pose and/or shape over multiple frames of the AR video). A virtual model may be a two-dimensional (2D) or three-dimensional (3D) model. A virtual model may include an audio component (e.g., sounds that are relevant to the virtual model).

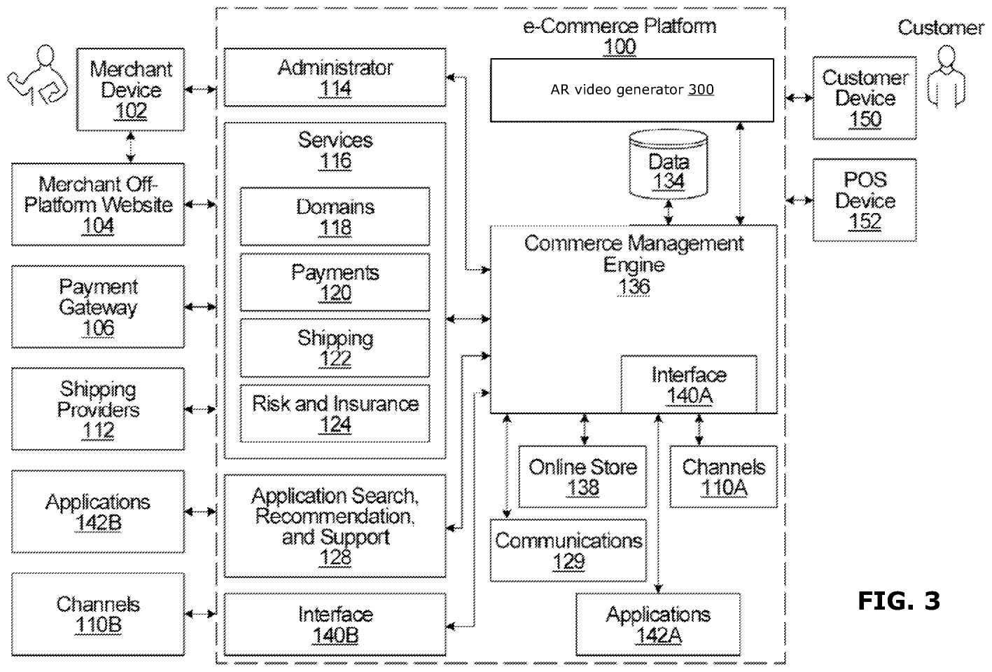

FIG. 3 illustrates the e-commerce platform 100 of FIG. 1 but including an AR video generator 300. The AR video generator 300 is an example of a computer-implemented system that implements the functionality described herein. Further details of the AR video generator 300 are discussed further below.

Although the AR video generator 300 is illustrated as a distinct component of the e-commerce platform 100 in FIG. 3, this is only an example. The AR video generator 300 could also or instead be provided by another component residing within or external to the e-commerce platform 100. In some embodiments, either or both of the applications 142A-B may provide an embodiment of the AR video generator 300 that implements the functionality described herein. The location of the AR video generator 300 may be implementation specific.

In some implementations, the AR video generator 300 may be provided at least in part by the e-commerce platform 100, either as a core function of the e-commerce platform 100 or as an application or service supported by or communicating with the e-commerce platform 100. For simplicity, the present disclosure describes the operation of the AR video generator 300 when the AR video generator 300 is implemented in the e-commerce platform 100, however this is not intended to be limiting. For example, at least some functions of the AR video generator 300 may by additionally or alternatively be implemented on the customer device 150 (e.g., an instance of the AR video generator 300 or certain functions of the AR video generator 300 may be implemented as an application executed by the customer device 150).

In some implementations, the examples disclosed herein may be implemented using a different platform that is not necessarily (or is not limited to) the e-commerce platform 100. In general, examples of the present disclosure are not intended to be limited to implementation on the e-commerce platform 100.

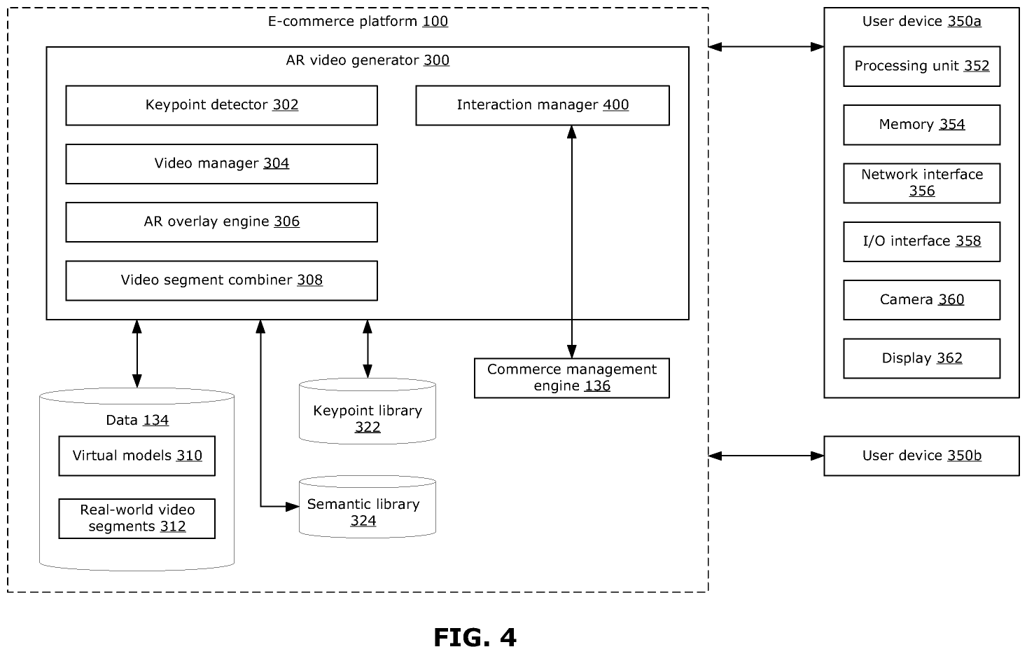

Reference is now made to FIG. 4, which is a block diagram showing further details of the AR video generator 300 in the context of the e-commerce platform 100. Some details of the e-commerce platform 100 are not shown, to avoid clutter. FIG. 4 illustrates other computing systems interacting with the e-commerce platform 100, including a first user device 350a and a second user device 352b. The first user device 350a and the second user device 352b may each be an instance of a customer device 150, for example.

For simplicity, only the first user device 350a is illustrated with details of its components. The first and second user devices 350a, 350b (which may generally be referred to as user device 350) may be similarly configured, or may be configured differently.

The user devices 350 may each be any electronic device capable of displaying an AR video. Examples of suitable electronic devices (which may or may not be AR-dedicated devices) include wearable devices (e.g., head-mounted display (HMD) devices, AR glasses, smart watches, etc.) and/or mobile devices (e.g., smartphones, tablets, laptops, etc.), among others. Examples of the present disclosure may also be implemented in non-wearable devices and/or non-mobile devices, such as desktop computing devices, workstations, tracking systems, and other computing devices.

In general, although the present disclosure makes reference to “first” and “second” user devices 350, it should be understood that there is not necessarily any relative ranking or priority between the user devices 350. The following examples are described in the context of a user interacting with the first user device 350a to generate an AR video, which can be shared with a user associated with the second user device 350b. However, it should be understood that the reverse may also take place. For simplicity, the user who interacts with the first user device 350a and who shares a generated AR video with other users may be referred to as the first user; the user who interacts with the second user device 350b and who may view a shared AR video may be referred to as the second user. The first user may share a generated AR video with multiple second users.

Example components of a user device 350 (which may be the first user device 350a or the second user device 350b) are now described, which are not intended to be limiting. It should be understood that there may be different implementations of the user device 350, and that the first and second user devices 350 may or may not be configured differently.

The user device 350 includes at least one processing unit 352, such as a processor, a microprocessor, an application-specific integrated circuit (ASIC), a field-programmable gate array (FPGA), a dedicated logic circuitry, a graphics processing unit (GPU), a central processing unit (CPU), a dedicated artificial intelligence processor unit, or combinations thereof.

The user device 350 includes at least one memory 354, which may include a volatile or non-volatile memory (e.g., a flash memory, a random access memory (RAM), and/or a read-only memory (ROM)). The non-transitory memory 354 may store instructions for execution by the processing unit 352, such as to enable communication with the AR video generator 300 and/or to enable viewing of a generated AR video.

The user device 350 includes at least one network interface 356 for wired or wireless communication with an external system or network (e.g., an intranet, the Internet, a P2P network, a WAN and/or a LAN), and in particular for communication with the e-commerce platform 100 in the example shown. In some examples, the network interface 356 may also enable the user devices 350 to communicate with each other via a network and/or directly (e.g., using device-to-device communications).

The user device 350 also includes at least one input/output (I/O) interface 358, which interfaces with input devices such as a camera 360, and output devices such as a display 362. In some examples, the same component may serve as both input and output device (e.g., the display 362 may be a touch-sensitive display). The camera 360 may be an optical camera that is capable of capturing a sequence of frames as video data. In some examples, the camera 360 may also be capable of capturing depth information (e.g., the camera 360 may include an infrared sensor), or the camera 360 may include multiple sub-cameras that each capture different types of video data (e.g., the camera 360 may be a combination of an optical sub-camera and an infrared sub-camera, such that the video data includes both RGB and depth data). The user device 350 may include other input devices (e.g., buttons, microphone, touchscreen, keyboard, etc.) and other output devices (e.g., speaker, vibration unit, etc.). The user device 350 may also include components that may sense the environment of the user device 350, such as a LIDAR sensor, an inertial measurement unit (IMU), an accelerometer, a gyroscope and/or a magnetometer, among other possibilities.

A first user may interact with the first user device 350a to create a user-specific set of products. For example, using an application executed on the user device 350a or using the user device 350a to interact with an application on the e-commerce platform 100, a first user may create a set (or list) of products that the first user may be interested in purchasing (e.g., a “wishlist” or a gift registry). In some examples, one or more products in the set of products may be added or recommended by the e-commerce platform 100 (instead of being added solely through input from the user). For example, a recommendation engine (not shown) of the e-commerce platform 100 may identify a most popular or highest selling product that fits the first user's demographic (e.g., based on demographic information indicated in a user profile associated with the user) and recommend the product to be added to the set of products for the first user. Similarly, the recommendation engine may recommend a product to add to the set of products based on the first user's browsing history, search history, similarity or complementarity to the user's previous purchases, etc. Various techniques may be used to automatically identify and recommend products to the first user. In some examples, one or more products in the set of products may be added by one or more other users (e.g., personal shopper(s), friend(s), family member(s), etc.), who may or may not be a second user (i.e., may or may not be a recipient of a shared AR video). For example, the first user may share the set of products with another user; or may provide permission for the other user to edit the set of products. The other user may, using an application executed on another user device 350 or using the other user device 350 to interact with an application on the e-commerce platform 100, add and/or remove products in the set of products.

Regardless of how the set of products is created, the result is a set of two or more products which is specific to the first user. The first user may wish to visualize the products in a real-world environment using AR, however it would be time consuming and require greater processing power to generate and display an AR video for each product one at a time (e.g., it would be onerous for the first user to have to navigate to the product page for each product, in order to load up a virtual model of that product, create an AR video with the virtual model in the user's real-world environment and then view the AR video; then repeat the process for each product in the set of products).

The products included in the set of products may not necessarily be limited to any one online store 138, and may not necessarily be limited to any one product category. For example, the set of products may include wearable products that are intended to be worn on different parts of the body (e.g., hat and shoes), may include different types of non-wearable products (e.g., vase and table), or may include both wearable and non-wearable products (e.g., hat and chair), among other possibilities. Thus, a technical challenge is how to generate an AR video in which virtual models of disparate products can be viewed in a real-world environment.

Some details of the AR video generator 300 are now discussed. The AR video generator 300 is shown to include components such as a keypoint detector 302, a video manager 304, an AR overlay engine 306 and a video segment combiner 308. It should be understood that these components are not intended to be limiting. For example, the AR video generator 300 may be implemented using greater or fewer components; component(s) shown to be part of the AR video generator 300 may be implemented outside of the AR video generator; functions described as being performed by a particular component may be performed by a different component; or functions described as being performed by any of the components may instead be an overall function of the AR video generator 300.

The AR video generator 300 communicates with the data facility 134, which in this example stores virtual models 310. Each virtual model 310 is associated with at least one product (which may be sold by an online store 138 (not shown in FIG. 4) of the e-commerce platform 100). A virtual model 310 may be a 3D model or a 2D model, for example.

In some examples, a virtual model 310 associated with a product may be uploaded by a merchant associated with the online store 138 selling the product. The merchant may identify the product (and associated virtual model 310) as belonging to a particular object class (e.g., by selecting from among available object classes recognized by the AR video generator 300). In some examples, the merchant may identify a product category, which may be recognized by the AR video generator 300 as an identified object class for the virtual model 310. In some examples, when a new virtual model 310 is added to the data facility 134 the AR video generator 300 (or other component of the e-commerce platform 100) may automatically identify the object class of the product associated with the virtual model 310. For example, the AR video generator 300 (or other component of the e-commerce platform 100) may use any suitable object recognition and classification algorithm (e.g., a neural network that has been trained to perform an object classification task) to automatically identify the object class based on an image of the product and/or based on the 3D data of the virtual model 310. An object label representing the object class of the product may be assigned to the virtual model 310 and/or the product.

The keypoint detector 302 may automatically identify one or more keypoints on the virtual model 310. Keypoints are commonly used in computer vision algorithms as a way to identify shape and/or pose of detected objects. A keypoint may also be referred to as a reference point, anchor point or landmark, for example. A keypoint is a location on a virtual model 310 that helps in positioning the virtual model 310 as an overlay onto a real-world video segment. For example, a virtual model 310 of a glove may have identified keypoints that correspond to the location of the tips and joints of the fingers. Then, by matching the keypoints of the virtual model 310 of the glove onto corresponding keypoints detected in a real-world hand (that is captured in a real-world video segment), the virtual model 310 of the glove may be overlaid in a way that matches the size and pose of the real-world hand, to provide the AR effect that the hand is wearing the glove. In another example, a virtual model 310 of a pair of glasses may have identified keypoints that correspond to the location of the bridge and temples of the glasses. Then, by matching the keypoints of the virtual model 310 of the pair of glasses onto corresponding keypoints (e.g., tip of nose and top of ears) detected in a real-world face (that is captured in a real-world video segment), the virtual model 310 of the pair of glasses may be overlaid in a way that provides the AR effect that the pair of glasses is being worn on the face.

Various techniques may be used by the keypoint detector 302 to identify keypoints on the virtual models 310. In some examples, a virtual model 310 may also have predefined keypoints (e.g., keypoints that were added by the model developer), and the keypoint detector 302 may simply recognize the predefined keypoints based on the object class of the product associated with the virtual model 310. For example, the AR video generator 300 may have access to a keypoint library 322 (which may be internal to the e-commerce platform 100 as shown, or may be external to the e-commerce platform 100). The keypoint library 322 may store a template of keypoints for each object class. The keypoint detector 302 may reference the keypoint library 322 in order to recognize the meaning of each predefined keypoint of a virtual model 310, for example.

In some examples, the keypoint detector 302 may employ a trained keypoint detection neural network to detect and recognize keypoints on the model. Different keypoint detection neural networks may be trained to detect and recognize keypoints for different object classes. For example, keypoint detection for hands is well-studied, and a keypoint detection neural network that has been trained to detect and recognize hand keypoints may be deployed for detecting and identifying keypoints of a virtual model 310 for a glove. Other keypoint detection neural networks may be trained (e.g., using supervised learning) to detect and identify keypoints for other object classes. In some examples a single keypoint detection neural network may be trained to detect and identify keypoints for multiple object classes (e.g., where the object label is included as input to the neural network).

Each virtual model 310 may be parameterized with variables such as color, size, texture, illumination, etc. By changing the parameter values, a virtual model 310 may be modified by the AR video generator 300 to more realistically fit into the real-world video segment (e.g., based on the illumination level of the real-world video segment, the illumination of the virtual model 310 may be correspondingly changed).

The AR video generator 300 includes a video manager 304, which may perform operations to manage real-world videos and video segments. The video manager 304 may perform operations to partition a real-world video (in particular a live real-world video that is captured in real-time as the AR video is being created) into multiple real-world video segments. The real-world video may be captured by the first user using the camera 360 of the first user device 350a, and may be communicated to the e-commerce platform 100 in real-time, to enable the video manager 304 to partition the real-world video in real-time as the real-world video is being captured at the user device 350a.

For example, the video manager 304 may process a real-world video using a motion detection algorithm, in order to detect a pause in motion (or a reduction in motion) in the real-world video. The detected pause may be used to partition the real-world video, for example by labeling the frame when a pause is first detected as the end of a previous video segment, and the frame when motion resumes as the start of a next video segment. In another example, the video manager 304 may partition the real-world video into video segments based on predefined time intervals (e.g., every five seconds of video is partitioned into a respective video segment). In another example, the video manager 304 may use machine learning techniques (e.g., using trained neural networks) to perform gesture recognition, in order to detect and recognize a gesture performed by a hand or head (or other body part) in the captured video. The video manager 304 may partition the real-world video based on the recognized gesture (e.g., a swipe gesture performed by a detected hand may be recognized as a “change” gesture that indicates the video should be partitioned into a new video segment starting from the detected gesture, or starting from the frame immediately following the end of the detected gesture). In another example, the video manager 304 may use computer vision (e.g., object detection and classification techniques, including machine learning-based techniques) to detect a change in scene, a change in active camera (e.g., switch from using a front-facing camera to a rear-facing camera), or a change of the foreground object (e.g., the largest detected object has changed, or the most centered object has changed), and the video may be partitioned based on the detected change (e.g., a new video segment may start at the frame when the change is first detected). In another example, the video manager 304 may partition the real-world video into video segments in response to user input at the first user device 350a (e.g., the first user may provide input at the user device 350a using a soft button, verbal input, etc.) indicating the start of a new video segment.

In some examples, in addition to or instead of using a live real-world video to partition into real-world video segments 312, a plurality of real-world video segments 312 may be pre-recorded by the first user and stored at the data facility 134. For example, the AR video generator 300 may provide a user interface or prompt that is displayed by the first user device 350a to prompt the first user to create specific pre-recorded video segments. For example, the first user may be prompted to pose their head, hand, wrist, etc. or may be prompted to capture a real-world video of their table, kitchen, window, etc. Each real-world video segment that is created by the first user may then be stored in the real-world video segments 312 maintained by the data facility 134.

Each stored real-world video segment 312 may be stored in association with metadata that may include an identifier of the first user (e.g., user ID) and/or one or more object labels representing one or more primary real-world objects (e.g., head, hand, table, etc.) captured in the real-world video segment 312. An object label may be assigned to the real-world video segment 312 based the prompt provided to the first user (e.g., a video segment that is captured after prompting the first user to pose their head may be assumed to include the user's head and may be labeled accordingly). In some examples, computer vision (e.g., object detection and classification techniques, including machine learning-based techniques) may be used to detect and classify a real-world object captured in the real-world video segment 312, and the real-world video segment 312 may be labeled with the object class accordingly.

In some examples, if computer vision is used to process the real-world video segment 312, the bounding box of each detected and classified object may also be included in the metadata stored with the real-world video segment 312. In some examples, if computer vision is used to process the real-world video segment 312, keypoints of a real-world object in the real-world video segment 312 may be identified (e.g., using a trained keypoint detection neural network of the keypoint detector 302), which may help to reduce the amount of processing required (which may help to reduce latency) to later generate the AR video segment. In some examples, if computer vision is used to process the real-world video segment 312, additional descriptive labels may be assigned to the real-world video segment 312 based on estimation of the pose and/or activity of the detected real-world object. For example, detected keypoints on a real-world human captured in the real-world video segment 312 may be processed by a human pose estimator (which may be a trained neural network, or a classical algorithm) to identify a pose or activity (e.g., “standing”, “walking”, “sitting”, etc.) that may be represented by an additional description label assigned to the real-world video segment 312.

A stored real-world video segments 312 may be later retrieved (e.g., based on the user ID and the object label) and used to generate an AR video segment for a particular user and using a particular virtual model 310, for example. In some examples, pre-recorded real-world video segments 312 may be stored in the memory 354 of the user device 350a instead (e.g., to ensure privacy), which case it may not be necessary to assign a user ID to the stored real-world video segment 312.

The AR overlay engine 306 performs operations to generate an AR video segment by overlaying a virtual model 310 of a particular product onto a particular real-world video segment (which may be a stored real-world video segment 312 or a live real-world video segment partitioned from a live real-world video).

As previously mentioned, a user-specific set of products may be created, for example by the first user interacting with the first user device 350a. The user-specific set of products may be communicated to the AR video generator 300.

For each product in the user-specific product list, the AR overlay engine 306 may assign a respective object class. For example, each product may have a product category label assigned by a merchant offering that product. The product category label may be mapped to an object class using a predefined mapping (e.g., a look-up table). While a product category may be useful for marketing or selling purposes (e.g., useful for indicating the target demographic), an object class may be more relevant for AR purposes (e.g., useful for identifying the relevant keypoints of the virtual model 310). For example, a product labeled as “sunglasses” may be mapped to the object class “glasses”; a product labeled as “evening gown” may be mapped to the object class “dress”; a product labeled as “nightstand” may be mapped to the object class “table”; and so forth. Alternatively, the object class may already be assigned to the product (e.g., by the merchant).

The AR overlay engine 306 may use the object class assigned to the product to identify one or more real-world objects that can be used to anchor the virtual model 310 in the real-world environment. For simplicity, the following discussion describes the example where the object class is assigned to the product, however it should be understood that similar operations may be carried out in the case where the object class is assigned to the virtual model 310 instead.

The AR overlay engine 306 may access a semantic library 324 (which may be internal to the e-commerce platform 100 as shown, or may be external to the e-commerce platform 100) that identifies real-world object(s) that is(are) semantically relevant to each object class (e.g., stored in a look-up table, or stored in a semantic tree). Using the semantic library 324, the AR overlay engine 306 may identify one or more real-world objects that can be used to anchor the virtual model 310 for each product in the set of products. There may be multiple relevant real-world objects that may be used to anchor virtual model 310 associated with a product belonging to a given object class (e.g., a vase can be anchored to a table or to the floor).

For each product in the set of products, the AR overlay engine 306 overlays the associated virtual model 310 on a real-world video segment to generate an AR video segment. After the entire set of products has been processed by the AR overlay engine 306, the result is a collection of AR video segments, where each AR video segment includes a respective virtual model 310 (associated with a respective product in the set of products) overlaid on a real-world video segment.

The AR overlay engine 306 may generate AR video segments using stored real-world video segments 312, live real-world video segments, or a combination thereof (e.g., if the AR overlay engine 306 is unable to find a stored real-world video segment 312 containing a relevant real-world object for a given product, the first user may be prompted to capture a live real-world video segment instead). Example operations of the AR overlay engine 306 for generating one AR video segment for one product in the set of products are now described.

For simplicity, the following discussion describes the example where there is one product featured in one AR video segment (i.e., one virtual model 310 associated with one product is rendered as an overlay). However, it should be understood that in other examples there may be two or more virtual models 310 rendered as overlays in a given AR video segment. For example, a given product may be associated with two or more virtual models 310 (e.g., a product that is a dining set may be associated with virtual models 310 for both table and chairs), may be associated with multiple instances of the same virtual model 310 (e.g., a pair of shoes may be associated with two instances of the virtual model 310 for one shoe) or the first user may have an option for virtually visualizing two or more products together (e.g., the first user may have the option to virtually try on a shirt together with a jacket).

In an example where a live real-world video segment is used to generate the AR video segment for a given product in the set of product, the AR overlay engine 306 may first identify the relevant real-world object that may be used to anchor the virtual model 310 associated with the given product (e.g., using the semantic library 324 as discussed above). The AR overlay engine 306 may cause the first user device 350a to generate a prompt to the first user to capture a live video that includes the identified relevant real-world object. For example, if the given product is a wristwatch, the AR overlay engine 306 may identify a wrist as the relevant real-world object and may cause the user device 350a to prompt the first user to capture a live video of the wrist.

In another example, instead of prompting the first user to capture a certain real-world object, the AR overlay engine 306 may use a trained object detection and classification neural network to detect a primary real-world object in the live real-world video segment, and select the virtual model 310 associated with the given product based on relevancy between the detected real-world object and the object class of product.

For example, if a live real-world video is being captured by the first user using the first user device 350a, the live video may be partitioned into real-world video segments as discussed above, and for each real-world video segment the primary real-world object may be detected and classified by the trained object detection and classification neural network of the AR overlay engine 306. Keypoints of the real-world object may also be detected (e.g., using the keypoint detection neural network of the keypoint detector 302). Then, based on the predicted class of the detected real-world object, the AR overlay engine 306 may identify a relevant product from the product list (i.e., a product having an object class that is relevant to the object class of the detected real-world object). The virtual model 310 associated with the identified product may then be rendered as an overlay onto the real-world video segment. Identified keypoints of the virtual model 310 may be anchored to relevant keypoints detected on the real-world object, in order to properly position the overlay in the real-world video segment.

In this way, the AR overlay engine 306 may automatically identify the product in the set of products that is appropriate to be overlaid onto the real-world video segment, based on the real-world object in the real-world video segment. Further, if the real-world object changes (e.g., the live real-world video changes to capture a different real-world object) this may automatically result in partitioning of the video into a new real-world video segment and another product may be identified to be overlaid onto the new real-world video segment. Notably, the generated AR video is customized to the user-specific set of products, without requiring the first user to view separate AR videos for each product and without restricting the set of products to a particular product category or particular online store. Thus, the AR overlay engine 306 enables different products (which may include products belonging to different product categories and different object classes) to be dynamically selected from the set of products, based on relevancy to real-world objects captured in a live real-world video, so that the generated AR video segments are more realistic and naturalistic (e.g., each product is virtually visualized in a semantically relevant real-world context).

In an example where a stored real-world video segment 312 is used, the AR overlay engine 306 may identify, from the stored real-world video segments 312 in the data facility 134 (and in particular the stored real-world video segments 312 that are associated with the user ID of the first user), the appropriate real-world video segment 312 for a given product in the product list. For example, after identifying the relevant real-world object for the given product (e.g., based on semantic relevancy to the object class of the product), the AR overlay engine 306 may identify the stored real-world video segment 312 that has metadata including an object label corresponding to the identified relevant real-world object. For example, if the given product is a vase, the AR overlay engine 306 may identify a table as a relevant real-world object, and may then identify a stored real-world video segment 312 that is annotated with a label for the table object class.

In this way, the AR overlay engine 306 may automatically match a stored real-world video segment 312 with each product in the set of products, in order to generate the AR video segments. Notably, the generated AR video is customized to the user-specific set of products, without requiring the first user to manually select which real-world video segment 312 to use for virtually visually each product and without restricting the set of products to a particular product category or particular online store. In particular, the AR overlay engine 306 enables different products (which may include products belonging to different product categories and different object classes) to be matched with different stored real-world video segments 312 (which feature real-world objects belonging to different object classes), so that the generated AR video segments are more realistic and naturalistic (e.g., each product is virtually visualized in a semantically relevant real-world context).

In some examples, the same real-world video segment may be overlaid with two or more different virtual models 310 to generate two or more different AR video segments. For example, if the set of products includes two different products that have the same relevant real-world object (e.g., a real-world head may be relevant to both glasses and hat), a stored real-world video segment 312 that contains the relevant real-world object may be retrieved from the data facility 134 (e.g., based on the object label(s) assigned to each stored real-world video segment 312; and optionally based on the user ID of each stored real-world video segment 312) and used to generate the AR video segment for both products.

The AR video segments may be generated by the AR overlay engine 306 according to a default order (e.g., in the order that products were added to the set of products by the first user). Alternatively, the AR video segments may be generated according to an arranged order that groups products together that are relevant to the same real-world object class. Alternatively, the AR video segments may be generated according to an order that is dependent on the order of the real-world objects detected in a live real-world video.

The generated AR video segments are combined into a single, continuous AR video by the video segment combiner 308. The generated AR video segments are combined in a manner such that they appear to be a single seamless video. For example, the video segment combiner 308 may adjust the audio and illumination levels of each AR video segment to smoothly transition between AR video segments. Notably, although the AR video segments may be generated by the AR overlay engine 306 in a particular order, the AR video segments may be combined in a different order into the AR video. Even if the AR video segments are generated by partitioning a live real-world video, the order of the AR video segments may be rearranged and appropriate adjustments (e.g., fade in/out of audio, balancing of illumination levels, etc.) may be performed by the video segment combiner 308 to give a seamless appearance to the AR video.

The AR video segments may be combined into a single, continuous AR video, where the AR video is a single data unit (e.g., a single video file). In other examples, the AR video segments may be processed by the video segment combiner 308 on-the-fly (e.g., in real-time when the AR video is viewed) such that the AR video segments are streamed sequentially, in a way that the streamed AR video segments are perceived by a viewer as a continuous AR video, without the AR video actually being a single data unit. For example, a seamless AR video may be provided by playback of multiple AR video segments sequentially, with video processing techniques applied (e.g., fade in/out of audio, balancing of illumination levels, etc.) to smoothly transition between the end of one AR video segment and the start of the next AR video segment, such that the AR video is viewed as a seamless or continuous (e.g., non-interrupted) video.

In some examples, such as where the AR video is intended to be shared with multiple second users (e.g., to solicit feedback on the products in the set of products), different AR videos may be generated from the same collection of AR video segments, by combining the AR video segments in different sequential order (e.g., randomized order), to avoid the possibility of sequence bias (e.g., the first-viewed product can be subconsciously preferred).

In some examples (e.g., where only live real-world video segments are used to generate the AR video segments), there may not be any need to combine the AR video segments into a single, continuous AR video. For example, a live real-world video may be logically partitioned into real-world video segments (e.g., for the purpose of having a different virtual model 310 rendered to overlay each video segment), but not actually partitioned into discrete data portions. Thus, the AR video may be generated from a live real-world video simply by rendering different virtual models 310 to overlay different segments of the live video, without having to separate out the live real-world video into discrete data portions and recombining into the AR video.

The AR video (or multiple AR videos) generated from the set of products may be shared with one or more second users (e.g., may be directly shared with a second user device 350b associated with a second user and/or the second user device 350b may be provided with access to the AR video via a link generated by the e-commerce platform 100). An interaction manager 400 may manage how the second users interact with the shared AR video. In the example shown, the interaction manager 400 is a component of the AR video generator 300. In other examples, the interaction manager 400 may be a component of the e-commerce platform 100 that is outside of the AR video generator 300.

For example, the interaction manager 400 may track feedback from one or more second user devices 350b, in response to the shared AR video. The tracked feedback may be feedback with respect to the AR video as a whole or with respect to the individual AR video segments. For example, when the AR video is viewed on the second user device(s) 350b, there may also be feedback mechanisms (e.g., comment box, upvote button, etc.) displayed to enable feedback to be provided.

The interaction manager 400 may also enable a second user, via the second user device 350b, to edit or otherwise modify the AR video. For example, the interaction manager 400 may provide a user interface to the second user device 350b to enable the second user to select a new product to add to the set of products. The AR video generator 300 may process the added product in the manner described above to generate a new AR video segment for the new product. In particular, the new AR video segment may be generated using a real-world video segment associated with the first user. For example, the AR video generator 300 may identify a stored real-world video segment 312 of the first user to be used to generate the new AR video segment. In another example, the AR video generator 300 may identify an AR video segment of the shared AR video that contains a real-world object that is relevant to the added product (e.g., using operations described above). The underlying real-world video segment may be extracted from the identified AR video segment (e.g., by removing the existing virtual overlay) and used to generate the new AR video segment by overlaying the virtual model 310 associated with the added product. In another example, the second user may capture or otherwise provide a new real-world video segment to be used to generate the new AR video segment. The new AR video segment may then be added to the existing AR video (e.g., using the video segment combiner 308) to extend the AR video. When the new AR video segment is added to the existing AR video, the interaction manager 400 may also automatically add the product that is featured in the new AR video segment to the first user's set of products. In another example, the new AR video segment may replace an existing AR video segment of the shared AR video (e.g., using the video segment combiner 308 to remove the existing AR video segment and combine the new AR video segment). When the new AR video segment replaces an existing AR video segment, the interaction manager 400 may also automatically add the product that is featured in the new AR video segment to the first user's set of products and remove the product that is featured in the replaced AR video segment from the list products. In some examples, the interaction manager 400 may generate a notification to the first user (e.g., displayed by the first user device 350a) prior to modifying the set of products, and may modify the set of products only after receiving approval from the first user (e.g., via the first user device 350a). It should be noted that, even if the set of products is modified by a second user, the set of products is still considered to be user-specific to the first user (e.g., associated with the user ID of the first user).

The interaction manager 400 may aggregate feedback from all second users, which may include: tallying upvotes on each individual AR video segment, averaging ratings on each individual AR video segment, compiling all comments, collecting all new AR video segments created by second users, etc. The aggregated feedback may then be provided back to the first user via the first user device 350a. In some examples, the interaction manager 400 may also provide the aggregated feedback to one or more second users. If the aggregated feedback is provided to a second user, the second user may also be provided an option to add a top-voted product to their own user-specific set of products (e.g., a “wishlist” or gift registry of the second user, which may be associated with a user ID of the second user).

In some examples, the interaction manager 400 may enable the AR video to be shared with one or more second users as part of an interactive poll, in which each second user may view the AR video and vote on individual AR video segments (e.g., to indicate which product they prefer). It should be noted that the interactive poll may enable a second user to provide feedback that includes more data than a vote. As described above, feedback from a second user may include data-rich feedback such as comments, replacing an existing product in the set of products with a new product and/or adding a new product to the set of products. The interactive poll may thus enable the first user to receive feedback from one or more second users on the products in the first user's set of products.

The interaction manager 400 may enable the first user to set one or more parameters of the interactive poll, prior to sharing the interactive poll. For example, the first user may set a poll end condition (e.g., end the poll after a set time duration, after a set date, after receiving a set minimum or maximum number of votes from second users, after a set number of products in the set of products have received a set minimum or maximum number of votes, etc.). The first user may also set permissions and/or restrictions on the ability of second user(s) to modify the set of products (e.g., set restriction that only certain permitted second users may modify the set of products, set requirement to notify the first user before modifying the set of products, etc.). If modification of the set of products is permitted, the first user may set parameters or restrictions on the products that may be added to or removed from the set of products (e.g., set restriction against removing certain products from the set of products, set restriction on the product category of products that can be added to the set of products, set restrictions on the price range of products that can be added to the set of products, set restrictions on the number of products that can be added to the set of products, etc.). In some examples, if the first user does not set any parameters for the interactive poll, the interaction manager 400 may automatically apply a default set of parameters (e.g., may apply the most conservative parameters by default).

In some examples, the interaction manager 400 may cooperate with the commerce management engine 136 to enable one or more transactions to be at least partially carried out, in response to the aggregated feedback. For example, a parameter that may be set by the first user is to enable automatic purchase of a top-voted product in the set of products. For example, financial information associated with the first user may already be stored or otherwise securely accessible by the commerce management engine 136. If the first user enables automatic purchase, the interaction manager 400 may identify the top-voted product based on the aggregated feedback (e.g., the product having the highest total number of upvotes, or the product having the highest average rating, etc.) and may provide the product identifier to the commerce management engine 136, to enable the commerce management engine 136 to automatically complete a transaction to purchase the identified product on behalf of the first user.

In another example, instead of completing the transaction automatically, the transaction may be automatically initiated (e.g., with all relevant fields on the checkout page completed, including financial information of the first user and product selection). The first user may then be provided a link to the initiated transaction page (e.g., the at least partially completed checkout page), where the user may select an option to approve and complete the transaction.

In some examples, the interaction manager 400 may also cooperate with the commerce management engine 136 to enable one or more transactions to be at least partially carried out on behalf of a second user. For example, if the aggregated feedback is provided to a second user, the aggregated feedback may also include a link to an initiated transaction page for the top-voted product (e.g., a checkout page for purchasing the top-voted product). If the second user has their financial information stored or accessible by the commerce management engine 136, the financial information of the second user may also be automatically completed on the transaction page. In some examples, the second user may be provided an option to initiate a transaction for the top-voted product or other product (e.g., second-highest voted product) for themselves or as a present to the first user, for example.

In some examples, the interaction manager 400 may perform operations to manage an interactive poll independently of the AR video.

For example, the interaction manager 400 may enable a first user associated with the first user device 350a to share a poll with one or more second users associated with one or more second user devices 350b, where the poll may include (e.g., in a list) the set of products that is user-specific for the first user.

The interactive poll may be shared with (e.g., accessible via a link) one or more second users, and the interaction manager 400 may collect feedback received from the second user(s) via the second user device(s) 350b.

The feedback may include, for example, a comment on the poll and/or a particular product listed in the poll, an upvote for a product in the poll, or a selection of an additional product (not originally included in the set of products), for example. In some examples, if the feedback includes an additional product, the additional product may be added as an additional selection in the interactive poll, or may replace an existing product in the interactive poll. In some examples, the first user may be notified if a second user wishes to modify the interactive poll, and the modification may be carried out only in response to input at the first user device 350a indicating approval of the modification.

Feedback collected from the one or more second user devices may be outputted to the first user device. The manner in which the feedback is aggregated and outputted may depend on the type of feedback provided. For example, if the feedback includes upvotes, the feedback may be outputted to the first user device as the tallied number of upvotes for each product in the set of products included in the poll. If the feedback includes ratings, the feedback may be outputted to the first user device as average ratings for each product. If the feedback includes an additional product, the feedback may include the modified poll (and optionally a link to the product page for the additional product).

Optionally (e.g., if the first user had set a parameter enabling a transaction to be carried out based on the feedback from the interactive poll) a transaction for a particular product in the set of products may be automatically carried out (at least partially), based on the feedback. For example, if the feedback includes a positive response to a particular product, then a transaction may be at least initiated for the product having the highest positive response (e.g., highest number of upvotes, or highest average rating). In some examples, the transaction may be at least partially carried out using stored financial information associated with the first user device, or a transaction (e.g., purchase) for the particular product may be completed (e.g., via cooperation with the commerce management engine 136 of the e-commerce platform 100). A link to the initiated transaction, or a notification of the completed transaction may be provided to the first user device, for example.

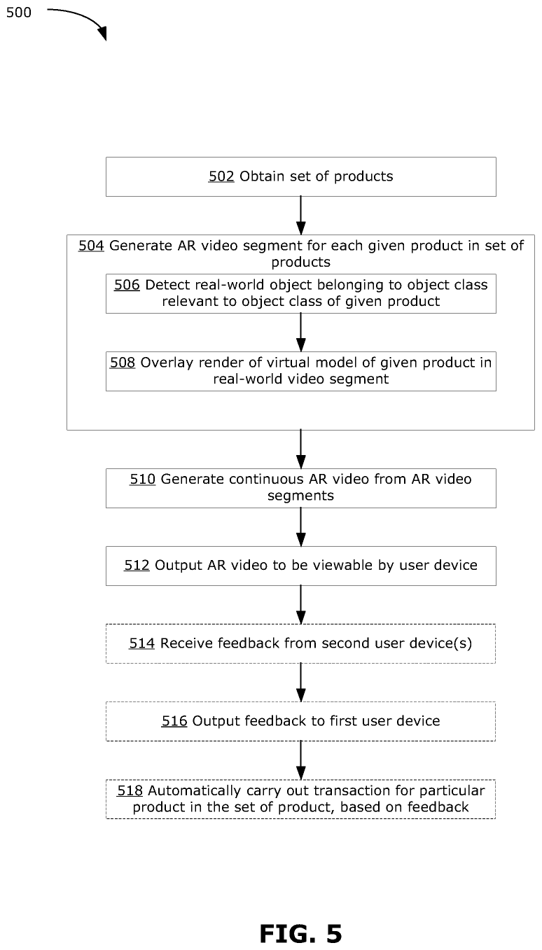

FIG. 5 is a flowchart illustrating an example method 500 that may be performed by the e-commerce platform 100, for example using the AR video generator 300. For example, a computing system (e.g., a server, or a server cluster) having a processing unit implementing the e-commerce platform 100 (including the AR video generator 300) may execute computer-readable instructions to perform the method 500.

At an operation 502, a set of products (e.g., a list of products, or collection of products) is obtained. The set of products may be associated with a first user, for example. The set of products may be created by the first user or by another user on behalf of the first user, or a combination thereof, as discussed above.

The set of products may be simply identifiers or references to the products, for example. Each product in the set of products may be available for purchase at an online store, for example. Each product is associated with at least one respective virtual model (e.g., a 3D model) and a respective object class (e.g., indicated by an object label assigned to the product).

At an operation 504, a respective AR video segment is generated for each given product in the set of products. As described above, each AR video segment may be generated using a stored real-world video segment or a live real-world video segment. Regardless of whether a stored or live real-world video segment is used, the operation 504 may be performed using operations 506 and 508.

At an operation 506, a real-world object is detected in the real-world video segment. The real-world object belongs to an object class that is relevant (e.g., semantically relevant) to the object class associated with the given product. For example, the AR overlay engine 306 of the AR video generator 300 may perform operations, as discussed above, to detect and classify a real-world object in the real-world video segment (e.g., using a trained object detection and classification neural network). Keypoints of the real-world object may also be detected (e.g., using the keypoint detector 302 of the AR video generator 300).

At an operation 508, a render of the virtual model associated with the given product is overlaid in the real-world video segment, to obtain the respective AR video segment for the given product. The render of the virtual model may be overlaid in the real-world video segment relative to the detected real-world object that belongs to the object class that is relevant to the object class of the given product. For example, the render of the virtual model may be overlaid in a way that detected keypoints of the virtual model are anchored to (i.e., positioned in the video segment relative to) detected keypoints of the real-world object. This may provide the AR effect that enables the virtual model to be realistically visualized, virtually, in a real-world environment.

Regardless of how the operation 504 is performed, an operation 510 follows the operation 504.

At the operation 510, a continuous AR video is generated from the AR video segments. As previously mentioned, the AR video segments may be combined (e.g., by the video segment combiner 308) so that the AR video is viewed as a single, seamless video. The AR video may be a single data unit, for example. Alternatively, the AR video segments may be provided (e.g., streamed) in a way that the AR video segments together are perceived as a single AR video.

At an operation 512, the AR video is outputted (e.g., streamed) to be viewable by a user device. The AR video may be viewed by the first user via the first user device. Additionally or alternatively, the AR video may be viewed by a second user via a second user device. In other words, the AR video may be viewed by the user who is the originator of the set of products and/or may be viewed by a recipient of a shared AR video.

Optionally, at an operation 514, feedback from one or more second user devices may be received. For example, interaction with the AR video may be enabled by the interaction manager 400. The feedback may include, for example, a comment on the AR video and/or an AR video segment within the AR video, an upvote for a product featured in an AR video segment, or a selection of an additional product (not originally included in the set of products), for example. In some examples, if the feedback includes an additional product, a new AR video segment may be generated for the additional product (e.g., as described above). For example, a new AR video segment may be generated by identifying a real-world video segment (e.g., a stored real-world video segment, a real-world video segment that was used to generate an AR video segment in the AR video, or a new real-world video segment that may be captured live or provided by the second user device) that includes a real-world object belonging to an object class that is relevant to the object class of the additional product. Then, a render of the virtual model associated with the additional product may be overlaid in the identified real-world video segment (e.g., using the AR overlay engine 306) to obtain the new AR video segment.

Optionally, at an operation 516, feedback collected from the one or more second user devices may be outputted to the first user device. The manner in which the feedback is aggregated and outputted may depend on the type of feedback provided. For example, if the feedback includes upvotes, the feedback may be outputted to the first user device as the results of a poll. If the feedback includes ratings, the feedback may be outputted to the first user device as average ratings for each product. If the feedback includes an additional product (for which a new AR video segment has been generated), the feedback may include the new AR video segment (which may be added to the existing AR video, or may replace an existing AR video segment in the AR video).

Optionally, at an operation 518, a transaction for a particular product in the set of products may be automatically carried out (at least partially), based on the feedback. For example, if the feedback includes a positive response to a particular AR video segment, then a transaction may be at least initiated for the product associated with (e.g., featured in) the AR video segment having the highest positive response (e.g., highest number of upvotes, or highest average rating). In some examples, the transaction may be at least partially carried out using stored financial information associated with the first user device, or a transaction (e.g., purchase) for the particular product may be completed (e.g., via cooperation with the commerce management engine 136 of the e-commerce platform 100). A link to the initiated transaction, or a notification of the completed transaction may be provided to the first user device, for example.

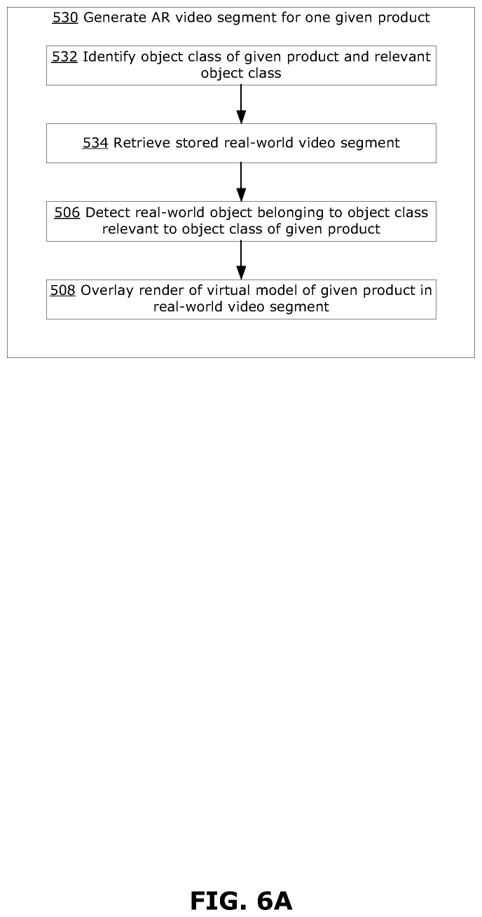

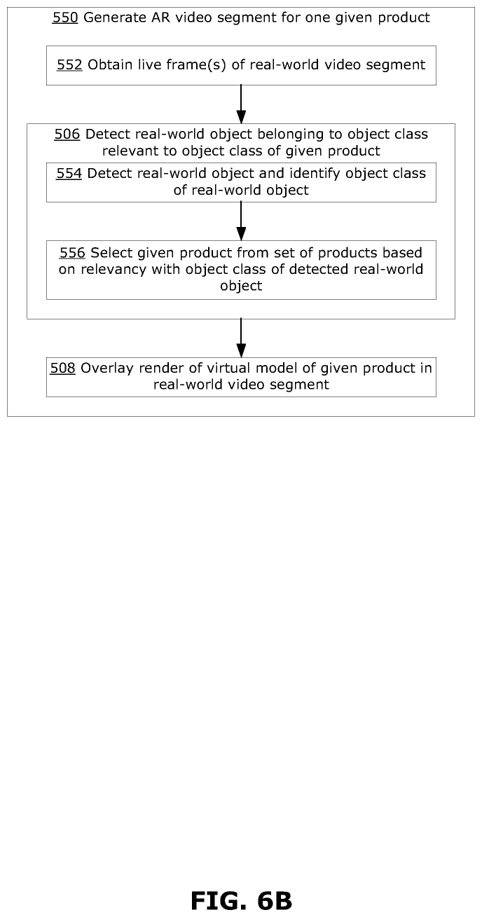

FIG. 6A is a flowchart illustrating further details of how the operation 504 may be carried out for at least one product in the set of products. FIG. 6A, in particular, illustrates an operation 530 for generating the AR video segment for one given product in the set of products using a stored real-world video segment.

At an operation 532, the object class of the given product is identified (e.g., based on the object label assigned to the given product). At least one object class that is relevant to the object class of the given product is also identified (e.g., using a semantic library). The relevant object class is an object class that can be used to anchor a virtual model of the given product in a real-world environment.

At an operation 534, a stored real-world video segment is retrieved (e.g., from a data facility 134 of the e-commerce platform 100). The stored real-world video segment is identified based on metadata (e.g., based on one or more object labels annotating the stored real-world video segment) that indicates the stored real-world video segment contains one or more real-world objects belonging to the relevant object class.

Following the operation 534, the operations 506 and 508 may be performed as described above. In particular, if the metadata stored with the stored real-world video segment includes a bounding box and object label of each real-world object, detecting the real-world object belonging to the relevant object class may be performed by simply locating the bounding box of the real-world object belonging to the relevant object class within the stored real-world video segment.

FIG. 6B is a flowchart illustrating further details of how the operation 504 may be carried out for at least one product in the set of products. FIG. 6B, in particular, illustrates an operation 550 for generating the AR video segment for one given product in the set of products using a live real-world video segment.

The live real-world video segment may be partitioned from a live real-world video, as discussed previously. Partitioning of the real-world video segment from a live real-world video may be a logical partitioning of the real-world video, or may include partitioning the real-world video into discrete data units, for example.

The partitioning of the live real-world video into two or more real-world video segments may be performed as part of the operation 550, or as another operation prior to the operation 550. For example, as described above, a defined gesture may be detected (e.g., a static gesture detected in at least one frame of the live real-world video, or a dynamic gesture detected in a sequence of frames of the live real-world video) and a frame (e.g., the first frame when the gesture is detected and recognized, or a frame immediately following completion of the detected gesture) may be labeled as the start of a new real-world video segment based on the detected gesture. In another example, a frame may be labeled as the start of new real-world video segment based on a detected pause in motion in the live real-world video (e.g., the first frame when the pause is detected may be labeled as the start of the new real-world video segment, or a frame immediately following resumption of motion may be labeled as the start of the new real-world video segment). In another example, a new real-world video segment may be labeled based on a defined time interval (e.g., every five seconds of live video may be labeled as the start of a new video segment). In another example, a change in a real-world object (e.g., a change in the object class of the primary real-world object, or a change of scene, etc.) may be detected over a sequence of frames of the live real-world video and a frame (e.g., the first frame when the change is detected) may be labeled as the start of a new real-world video segment based on the detected change.

At an operation 532, the object class of the given product is identified (e.g., based on the object label assigned to the given product). At least one object class that is relevant to the object class of the given product is also identified (e.g., using a semantic library). The relevant object class is an object class that can be used to anchor a virtual model of the given product in a real-world environment.

The operation 506 may be performed using operations 554 and 556.

At the operation 554, a real-world object is detected in one or more live frames of the real-world video segment, and the object class of the real-world object is identified (e.g., using a trained object detection and classification neural network). In some examples, there may be multiple real-world objects detected in a live frame, in which case only the primary real-world object (e.g., the real-world object that is largest in the frame and/or most centered in the frame) may be considered.

At the operation 556, the given product is selected from the set of products based on relevancy (e.g., determined using a semantic library) between the object class of the detected real-world object and the object class of the given product.

Following the operation 506, the operation 508 may be performed as described above.

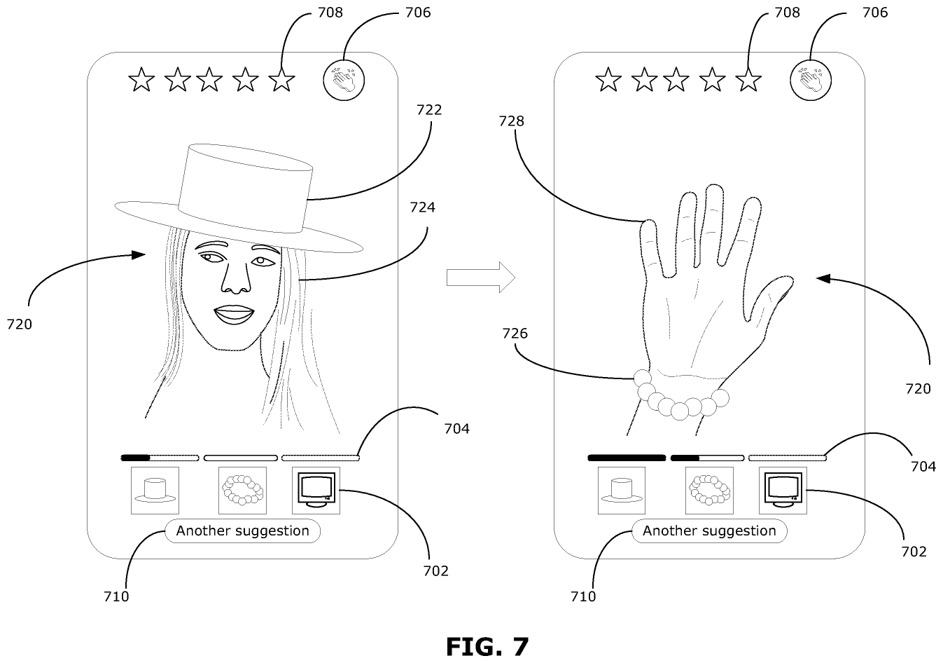

FIG. 7 illustrates a simple example of the AR video that may be generated in accordance with the present disclosure, for example using methods 500, 530 and/or 550 described above. In particular, FIG. 7 illustrates two example segments of an AR video that is generated from a user-specific set of products associated with a first user. In particular, the AR video in this example has been shared by the first user and is viewed by a second user via a second user device 350b, as part of an interactive poll.

The AR video may be displayed on the second user device 350b as part of an interface for the interactive poll, which may be managed by the interaction manager 400. In this example, the interface includes a playback 720 of the AR video, thumbnails 702 representing the products associated with each AR video segment, and a progress bar 704 representing progress through the AR video (which in this example is visually divided to represent the AR video segments associated with each product). It should be appreciated that there may be more than three products in the set of products, and there may be more than three AR video segments in the AR video. Each thumbnail 702 may be selectable to cause navigation to a product page for the product represented by the thumbnail 702, for example, or to cause the playback to skip to the AR video segment associated with the product. The interface may also include selectable options for providing feedback, such as an upvote button 706, rating selection 708 and option 710 for selecting an additional product to add to or replace a product in the set of products, as discussed above.

As illustrated in FIG. 7, different segments of the AR video may enable virtual visualization of different products in the set of products. In particular, FIG. 7 illustrates an example in which different products belonging to different product categories (and different object classes) may be virtually visualized using overlays on different real-world objects (belonging to different object classes). In this example, in a first AR video segment a virtual model of a hat 722 is rendered and overlaid on a real-world video segment that includes the real-world head 724 of the first user. In a second AR video segment, a virtual model of a bracelet 726 is rendered and overlaid on a real-world video segment that includes the real-world wrist 728 of the first user. The first and second AR video segments may have been generated using stored real-world video segments (e.g., using the method 530), using live real-world video segments (e.g., using the method 550), or both (e.g., one AR video segment may be generated using a stored real-world video segment using the method 530, and another AR video segment may be generated using a live real-world video segment using the method 550), which are then combined into the AR video.

In various examples, the present disclosure has described systems and methods that enable an AR video to be generated, which is customized to a user-specific set of products. In particular, each AR video segment in the AR video may be generated by matching each product to a real-world video segment that contains a real-world object relevant to the product to be featured in that AR video segment.

In some examples, if a live real-world video is being used to generate the AR video, the product that is relevant to the real-world object in the real-world video may be identified in real-time and the appropriate virtual model may be rendered as an overlay of the live real-world video in real-time. In some examples, in response to detecting a change in the real-world object or other trigger (e.g., gesture, pause in motion, change in scene, etc.) in the live real-world video, a different product that is relevant may be automatically identified and rendered as an overlay in real-time.

In some examples, if a stored real-world video segment is used to generate the AR video segment, an appropriate real-world video segment may be automatically identified and retrieved, based on relevancy between a real-world object in the stored real-world video segment and a product in the set of products that is to be featured in the AR video segment.

The present disclosure has also described systems and methods that enable the first user to share an interactive poll (which may or may not include a shared AR video) with one or more second users. In some examples, based on feedback from the interactive poll, a transaction may be (at least partially) automatically carried out on behalf of the first user. In some examples, the interactive poll may also enable a second user to provide feedback that modifies the shared AR video.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A system comprising:
a processing unit configured to execute instructions to cause the system to:
obtain a set of products, each product being associated with a respective virtual model and associated with a respective object class;
generate a respective augmented reality (AR) video segment for each given product in the set of products by:
detecting, in a real-world video segment, a real-world object belonging to a relevant object class that is relevant to the object class of the given product; and
overlaying a render of the virtual model associated with the given product in the real-world video segment to obtain the respective AR video segment, the render of the virtual model being overlaid relative to the detected real-world object belonging to the relevant object class;
generate a continuous AR video from the AR video segments; and
output the continuous AR video to be viewable by a user device.

2. The system of claim 1, wherein, for at least one product in the set of products, generating the respective AR video segment further comprises:
identifying the object class of the given product and identifying the relevant object class; and
retrieving a stored real-world video segment, wherein the stored real-world video segment is identified based on metadata indicating the stored real-world video segment contains one or more real-world objects belonging to the relevant object class.

3. The system of claim 1, wherein, for at least one product in the set of products, generating the respective AR video segment further comprises:
detecting the real-world object by:
obtaining one or more live frames of real-world video from the user device; and
detecting the real-world object and identifying the object class of the real-world object from the one or more live frames;
wherein the given product is selected from the set of products to generate the respective AR video segment based on relevancy between the object class of the real-world object and the object class of the given product.

4. The system of claim 3, wherein the processing unit is configured to execute instructions to further cause the system to:
detect, in a sequence of live frames a defined gesture or a pause in motion of the real-world object for at least a defined time threshold; and
responsive to the detecting, label at least one frame in the sequence of live frames as a start of a new real-world video segment.

5. The system of claim 3, wherein the processing unit is configured to execute instructions to further cause the system to:
detect, in a sequence of live frames a change from a first real-world object belonging to a first object class to a second real-world object belonging to a different second object class; and
responsive to the detecting, label at least one frame in the sequence of live frames as a start of a new real-world video segment.

6. The system of claim 1, wherein the user device is a first user device, and wherein the processing unit is configured to execute instructions to further cause the system to:
output the continuous AR video to be viewable by at least one second user device;
receive feedback, from the at least one second user device, with respect to the continuous AR video; and
output collected feedback to the first user device.

7. The system of claim 6, wherein the feedback comprises a selection of an additional product not included in the set of products, and wherein output of the collected feedback to the first user device includes a new AR video segment generated by:
identifying a real-world video segment associated with a first user associated with the first user device, the identified real-world video segment including a real-world object belonging to an object class that is relevant to an object class of the additional product; and
overlaying a render of a 3D model associated with the additional product in the identified real-world video segment to obtain the new AR video segment.

8. The system of claim 6, wherein the feedback comprises a positive response to at least one product associated with an AR video segment in the continuous AR video, and wherein the processing unit is configured to execute instructions to further cause the system to:
automatically complete a transaction to purchase a product associated with a AR video segment having a highest positive response from among all products associated with AR video segments in the continuous AR video, the transaction being completed using stored financial information associated with a first user associated with the first user device; and
wherein output of the collected feedback to the first user device includes an indication of the completed transaction.

9. The system of claim 1, wherein the system is the user device, and wherein the user device is one of:
a mobile communication device;
a tablet device;
a laptop device;
a wearable device; or
a desktop device.

10. A method comprising:
obtaining a set of products, each product being associated with a respective virtual model and associated with a respective object class;
generating a respective augmented reality (AR) video segment for each given product in the set of products by:
detecting, in a real-world video segment, a real-world object belonging to a relevant object class that is relevant to the object class of the given product; and
overlaying a render of the virtual model associated with the given product in the real-world video segment to obtain the respective AR video segment, the render of the virtual model being overlaid relative to the detected real-world object belonging to the relevant object class;
generating a continuous AR video from the AR video segments; and
outputting the continuous AR video to be viewable by a user device.

11. The method of claim 10, wherein, for at least one product in the set of products, generating the respective AR video segment further comprises:
identifying the object class of the given product and identifying the relevant object class; and
retrieving a stored real-world video segment, wherein the stored real-world video segment is identified based on metadata indicating the stored real-world video segment contains one or more real-world objects belonging to the relevant object class.

12. The method of claim 10, wherein, for at least one product in the set of products, generating the respective AR video segment further comprises:
detecting the real-world object by:
obtaining one or more live frames of real-world video from the user device; and
detecting the real-world object and identifying the object class of the real-world object from the one or more live frames;
wherein the given product is selected from the set of products to generate the respective AR video segment based on relevancy between the object class of the real-world object and the object class of the given product.

13. The method of claim 12, further comprising:
detecting, in a sequence of live frames a defined gesture or a pause in motion of the real-world object for at least a defined time threshold; and
responsive to the detecting, labeling at least one frame in the sequence of live frames as a start of a new real-world video segment.

14. The method of claim 12, further comprising:
detecting, in a sequence of live frames a change from a first real-world object belonging to a first object class to a second real-world object belonging to a different second object class; and
responsive to the detecting, labeling at least one frame in the sequence of live frames as a start of a new real-world video segment.

15. The method of claim 10, wherein the user device is a first user device, the method further comprising:
outputting the continuous AR video to be viewable by at least one second user device;
receiving feedback, from the at least one second user device, with respect to the continuous AR video; and
outputting collected feedback to the first user device.

16. The method of claim 15, wherein the feedback comprises a selection of an additional product not included in the set of products, and wherein output of the collected feedback to the first user device includes a new AR video segment generated by:
identifying a real-world video segment associated with a first user associated with the first user device, the identified real-world video segment including a real-world object belonging to an object class that is relevant to an object class of the additional product; and
overlaying a render of a 3D model associated with the additional product in the identified real-world video segment to obtain the new AR video segment.

17. The method of claim 15, wherein the feedback comprises a positive response to at least one product associated with an AR video segment in the continuous AR video, the method further comprising:
automatically completing a transaction to purchase a product associated with a AR video segment having a highest positive response from among all products associated with AR video segments in the continuous AR video, the transaction being completed using stored financial information associated with a first user associated with the first user device; and
wherein output of the collected feedback to the first user device includes an indication of the completed transaction.

18. A computer readable medium having instructions encoded thereon, wherein the instructions, when executed by a computing system, cause the computing system to:
obtain a set of products, each product being associated with a respective virtual model and associated with a respective object class;
generate a respective augmented reality (AR) video segment for each given product in the set of products by:
detecting, in a real-world video segment, a real-world object belonging to a relevant object class that is relevant to the object class of the given product; and
overlaying a render of the virtual model associated with the given product in the real-world video segment to obtain the respective AR video segment, the render of the virtual model being overlaid relative to the detected real-world object belonging to the relevant object class;
generate a continuous AR video from the AR video segments; and
output the continuous AR video to be viewable by a user device.

19. The computer readable medium of claim 18, wherein, for at least one product in the set of products, generating the respective AR video segment further comprises:
identifying the object class of the given product and identifying the relevant object class; and
retrieving a stored real-world video segment, wherein the stored real-world video segment is identified based on metadata indicating the stored real-world video segment contains one or more real-world objects belonging to the relevant object class.

20. The computer readable medium of claim 18, wherein, for at least one product in the set of products, generating the respective AR video segment further comprises:
detecting the real-world object by:
obtaining one or more live frames of real-world video from the user device; and
detecting the real-world object and identifying the object class of the real-world object from the one or more live frames;
wherein the given product is selected from the set of products to generate the respective AR video segment based on relevancy between the object class of the real-world object and the object class of the given product.
